(19) United States
(12) Patent Application Publication
(10) Pub. No.: US 2014/0205755 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/953,991

(22) Filed: Jul. 30, 2013

(30) Foreign Application Priority Data
Jan. 24, 2013 (TW) 102102574

(51) Int. Cl. B29C 59/02; B05C 9/12; B05D 3/10

(52) U.S. Cl. CPC B29C 59/022; B05D 3/107; B05C 9/12
USPC 427/333; 425/363; 118/600

(57) ABSTRACT

A molding roller includes a cylindrical main body and a seamless ring-shaped molding film. The main body has a circumferential surface. The molding film is directly formed on the circumferential surface. The molding film has a molding surface including a number of molding patterns. The molding film is made of polymer resin consisting of polydimethylsiloxane and a plurality of silica nanoparticles formed in polymer grids of the polydimethylsiloxane.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. However, the molding patterns are directly formed on the circumferential surface, therefore, when the molding patterns are destroyed, the metallic roller needs to be discarded. This results in a relatively high cost.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

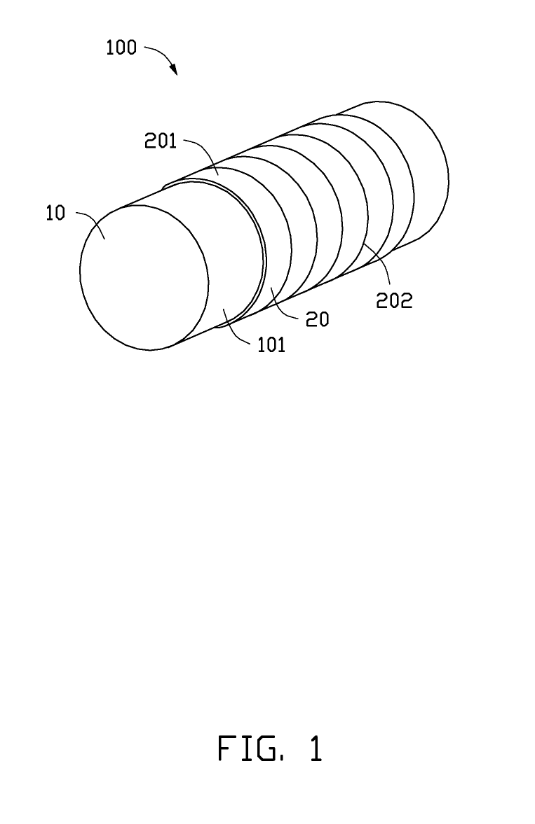

FIG. 1 illustrates a molding roller 100 in accordance with a first exemplary embodiment. The molding roller 100 includes a cylindrical main body 10 and a seamless ring-shaped molding film 20 directly formed on a circumferential surface 101 of the main body 10. The main body 10 can be made of stainless steel or other metals.

The molding film 20 includes a molding surface 201 opposite to the main body 10. The molding surface 201 includes a number of molding patterns 202. In the first embodiment, the molding patterns 202 are micro-protrusions.

The molding film 20 is made of polymer material. The polymer material consists of polymer resin and a number of silica nanoparticles formed in polymer grids of the polymer resin. In the first embodiment, the polymer resin is polydimethylsiloxane (PDMS) resin, and the silica nanoparticles are formed by sol-gel method.

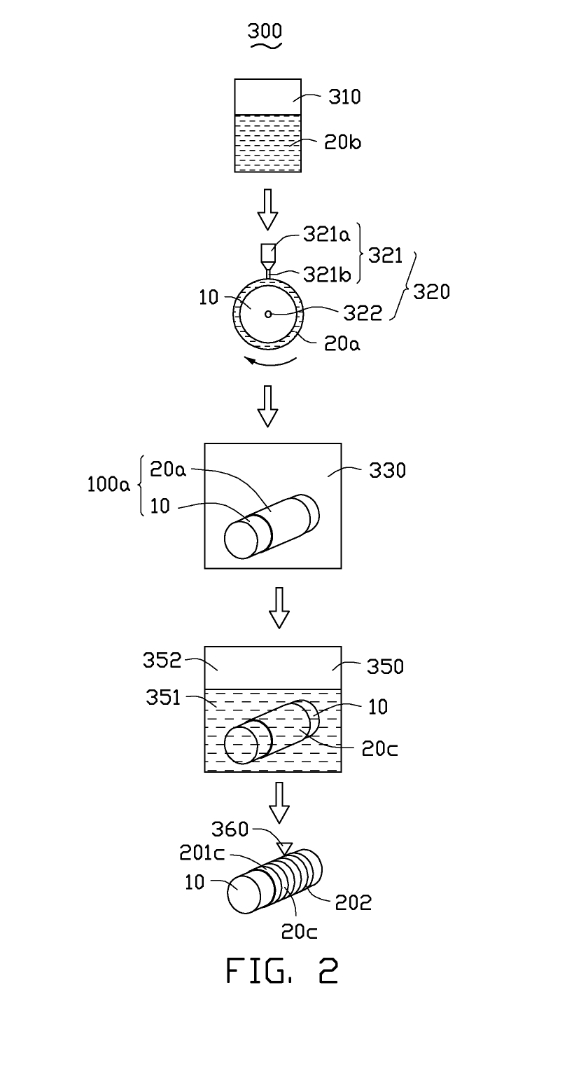

FIG. 2 shows an apparatus 300 for manufacturing the molding roller 100, according to a second exemplary embodiment. The apparatus 300 includes a mixing assembly 310, a coating device 320, a curing device 330, a film chemical treatment device 350, and a processing device 360.

The mixing assembly 310 is used for mixing a PDMS base and a curing agent according to hardness requirement. The PDMS base 311 a chemically reacts with the curing agent 311b to harden the PDMS base 311a, and thus the polymer resin 311c (i.e. PDMS resin) having polymer grids is obtained. The weight ratio of the PDMS base 311a to the curing agent 311b is about 10:1.

The coating device 320 is used for uniformly coating the polymer resin 20b on the circumferential surface 101 of the main body 10. In the first embodiment, the coating device 320 includes a feeder 321 and a rotating shaft 322. The rotating shaft 322 is configured for driving the main body 10 to rotate. The feeder 321 includes a receiving chamber 321a and an opening 321b communicating with the receiving chamber 321a. The receiving chamber 321a is used for receiving the polymer resin 20b. The opening 321b faces the main body 10, and thus the polymer resin 20b can arrive at the circumferential surface 101 through the opening 321b. When the main body 10 rotates, the polymer resin 20b is uniformly distributed on the circumferential surface 101.

Because the diameter of the opening 321b is very small (such as a few millimeters), the volume of each drop of the polymer resin 20b is very little, and the polymer resin 20b is viscous, therefore, the polymer resin 20b can be attached on the main body 10 when the rotating speed of the main body 10 is slow. At the same time, because the length of the main body 10 along the axial direction thereof is long (such as a few meters), the feeder 321a needs to move along the axial direction of the main body 10 to make sure the polymer resin 20b is distributed more uniformly on the circumferential surface 101 of the main body 10.

The curing device 330 is used for curing the polymer resin 20b on the circumferential surface 101 to obtain a seamless ring-shaped resin film 20a. In this embodiment, the curing device 330 is an oven, and the curing temperature is about 65° C.

The film chemical treatment device 350 is used for forming the silica nanoparticles in the polymer grids of the resin film 20a to form a preprocessed molding film 20c. The preprocessed molding film 20c has a preprocessed molding surface 201c opposite to the main body 10. The film chemical treatment device 350 includes a receiving chamber 352 for receiving a reaction liquid 351. The reaction liquid 351 includes dibutyl tin diacetate (DBTDA) and tetraethoxy silane (TEOS). The main body 10 with the resin film 20a is immersed in the reaction liquid 351 for a first predetermined period until the reaction liquid 351 penetrates the resin film 20a. Then the resin film 20a is taken out from the receiving chamber 352, and is placed in the air for a second predetermined period. Thus, the DBTDA can be hydrolyzed to obtain acetic acid, and the acetic acid accelerates the reaction of the TEOS with the resin film 20a to form the silica nanoparticles in the polymer grids of the resin film 20a. In the second embodiment, the resin film 20a is made of PDMS resin.

The processing device 360 is used for forming molding patterns 202 on the preprocessed molding surface 201c to obtain the molding film 20. The molding film 20 and the main body 10 cooperate to form the molding roller 100. The processing device 360 can include a diamond knife or a laser knife.

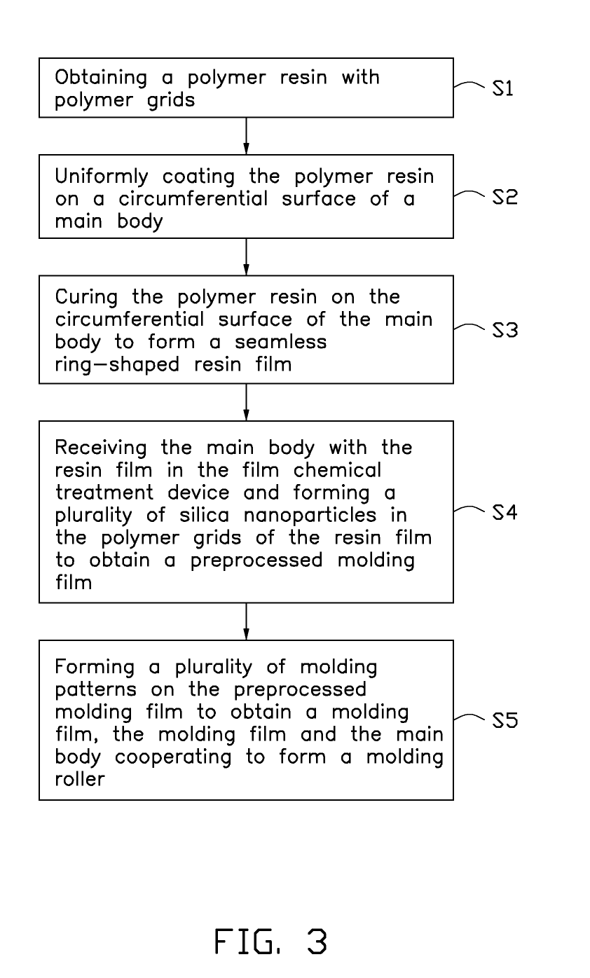

FIG. 3 illustrates a method for manufacturing the molding roller 100 using the apparatus 300 of FIG. 2 according to a third exemplary embodiment. The apparatus 300 includes the following steps.

In step S1, the PDMS base is mixed with the curing agent according to hardness requirement, the PDMS base 311a chemically reacts with the curing agent 311b to harden the PDMS base 311a, and thus the polymer resin 20b (i.e. PDMS resin) having polymer grid is obtained. In the third embodiment, the weight ratio of the PDMS base to the curing agent is about 10:1.

In step S2, the polymer resin 20b is uniformly distributed on the circumferential surface 101 of the main body 10 using the coating device 320.

In step S3, the curing device 330 cures the polymer resin 20b on the circumferential surface 101 of the main body 10, and thus to obtain a seamless ring-shaped resin film 20a. In the third embodiment, the curing device 330 is an oven, and the main body 10 with the polymer resin 20b is received in the oven.

In step S4, the main body 10 with the resin film 20a is received in the film chemical treatment device 350 to form a number of silica nanoparticles in the polymer grids of the resin film 20a, and thus the preprocessed molding film 20c is obtained. The preprocessed molding film 20c has the preprocessed molding surface 201c opposite to the main body 10.

In step S5, a number of molding patterns 202 are formed on the preprocessed molding surface 201c using the processing device 360, and thus the molding film 20 is obtained. The molding film 20 and the main body 10 cooperate to form the molding roller 100.

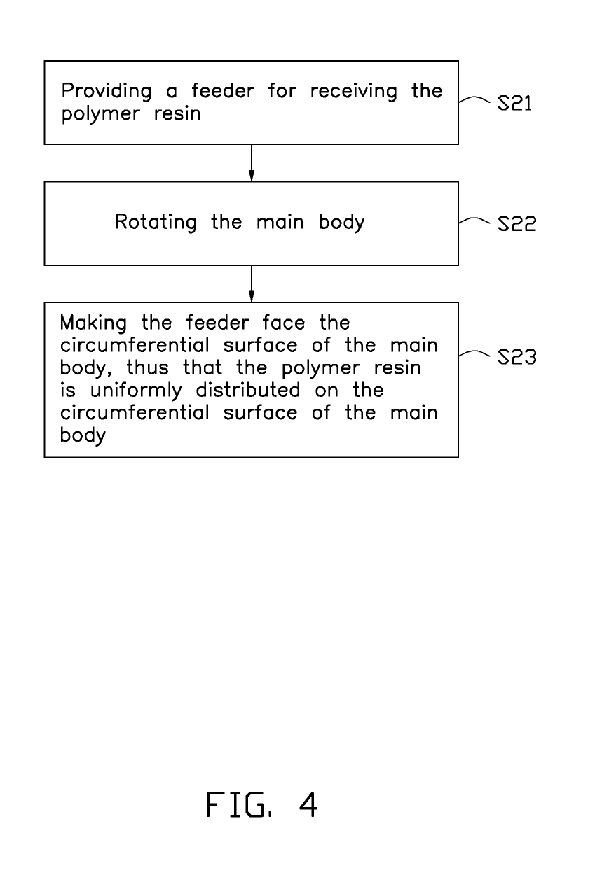

FIG. 4 illustrates that the step S2 further includes the following sub-steps.

In step S21, a feeder 321 is provided, the feeder 321 receives the polymer resin 20b.

In step S22, the main body 10 is rotated using the rotating shaft 322.

In step S23, the feeder 321 faces the circumferential surface 101 of the main body 10, and thus the polymer resin 20b is uniformly distributed on the circumferential surface 101 of the main body 10 via the opening 321b.

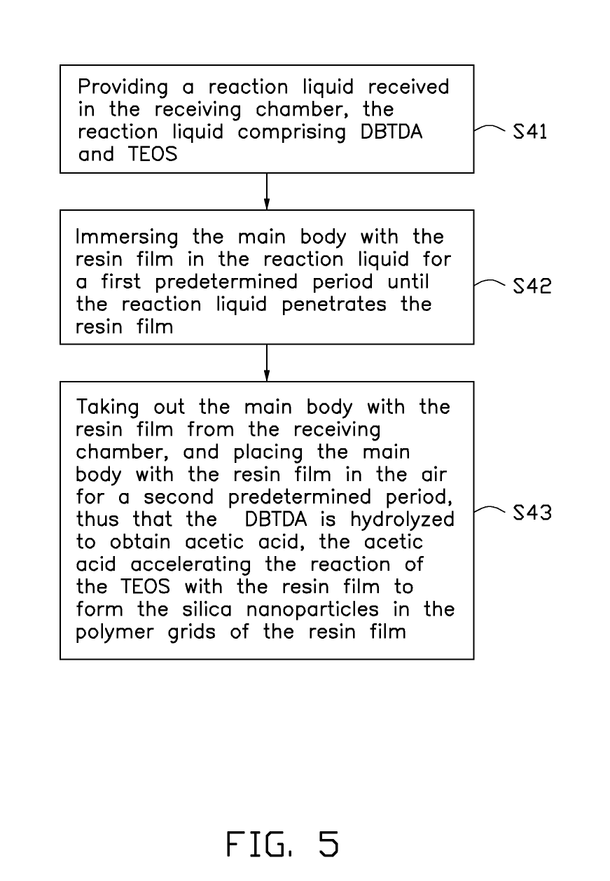

FIG. 5 illustrates that the step S5 includes the following sub-steps.

In step S51, the reaction liquid 351 is provided and is received in the receiving chamber 352, and the reaction liquid 351 includes DBTDA and TEOS.

In step S52, the main body 10 with the resin film 20a is immersed in the reaction liquid 351 for the first predetermined period until the reaction liquid 330b penetrates the resin film 20a.

In step S53, the main body 10 with the resin film 20a is taken out from the receiving chamber 352, and is placed in the air for the second predetermined period, and thus the DBTDA is hydrolyzed to obtain acetic acid. The acetic acid can accelerate the reaction of the TEOS with the resin film 20a to form the silica nanoparticles in the polymer grids of the resin film 20a.

By employing the apparatus 300 and the above described method, the molding patterns 202 are formed on the molding film 20. Therefore, when the molding patterns 202 are destroyed, the molding film 20 can be removed from the main body 10, and another new molding film 20 can be formed on the main body 10 to form a new molding roller 100. Therefore, the main body 10 can be used more times, and the molding roller 100 has a relatively low cost.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a circumferential surface; and
a seamless ring-shaped molding film directly formed on the circumferential surface, the molding film having a molding surface opposite to the main body, and the molding surface having a plurality of molding patterns;
wherein the molding film is made of polymer material consisting of polydimethylsiloxane resin and a plurality of silica nanoparticles formed in polymer grids of the polydimethylsiloxane resin.

2. The molding roller of claim 1, wherein the silica nanoparticles are formed in polymer grids of the polydimethylsiloxane resin by sol-gel method.

3. The molding roller of claim 1, wherein the main body is made of metal.

4. An apparatus for manufacturing a molding roller, comprising:
a mixing device configured for obtaining a polymer resin with polymer grids;
a coating device for uniformly coating the polymer resin on a circumferential surface of a main body;
a curing device for curing the polymer resin on the circumferential surface of the main body to form a seamless ring-shaped resin film;
a film chemical treatment device configured for receiving the main body with the resin film and forming a plurality of silica nanoparticles in the polymer grids of the resin film to obtain a preprocessed molding film; and
a processing device configured for forming a plurality of molding patterns on the preprocessed molding film to obtain a molding film, and the molding film and the main body cooperating to form the molding roller.

5. The apparatus of claim 4, wherein the film chemical treatment device comprises a receiving chamber for receiving a reaction liquid, the reaction liquid comprises dibutyl tin diacetate and tetraethoxy silane, when the main body with the resin film is immersed in the reaction liquid for a first predetermined period, the reaction liquid penetrates the resin film, then the resin film is taken out from the receiving chamber, and is placed in the air for a second predetermined period, the dibutyl tin diacetate is hydrolyzed to obtain acetic acid, the acetic acid accelerates the reaction of the tetraethoxy silane with the resin film to form the silica nanoparticles in the polymer grids of the resin film.

6. The apparatus of claim 4, wherein the coating device comprises a feeder and a rotating shaft, the feeder comprises a receiving chamber and an opening communicating with the receiving chamber, the receiving chamber is configured for receiving the polymer resin, the opening is configured for facing the main body, the rotating shaft is configured for rotating the main body to make the polymer resin uniformly distributed on the circumferential surface of the main body.

7. The apparatus of claim 4, wherein the curing device comprises an oven, the oven is configured for receiving the main body with the resin film.

8. A method for manufacturing a molding roller, comprising:
obtaining a polymer resin with polymer grids;
uniformly coating the polymer resin on a circumferential surface of a main body;
curing the polymer resin on the circumferential surface of the main body to form a seamless ring-shaped resin film;
receiving the main body with the resin film in a film chemical treatment device and forming a plurality of silica nanoparticles in the polymer grids of the resin film to obtain a preprocessed molding film; and
forming a plurality of molding patterns on the preprocessed molding film to obtain a molding film, the molding film and the main body cooperating to form the molding roller.

9. The method of claim 8, wherein the step of obtaining a polymer resin with polymer grids further comprises: providing a polydimethylsiloxane base and a curing agent; and mixing the polydimethylsiloxane base and the curing agent to obtain the polymer resin.

10. The method of claim 8, wherein the step of receiving the main body with the resin film in the film chemical treatment device and forming a plurality of silica nanoparticles in the polymer grids of the resin film to obtain a preprocessed molding film further comprises:
providing a reaction liquid received in a receiving chamber, the reaction liquid comprising dibutyl tin diacetate and tetraethoxy silane;
immersing the main body with the resin film in the reaction liquid for a first predetermined period until the reaction liquid penetrates the resin film;
taking out the main body with the resin film from the receiving chamber; and
placing the main body with the resin film in the air for a second predetermined period, such that the dibutyl tin diacetate is hydrolyzed to obtain acetic acid, the acetic acid accelerating the reaction of the tetraethoxy silane with the resin film to form the silica nanoparticles in the polymer grids of the resin film.

11. The method of claim 8, wherein the step of uniformly coating the polymer resin on a circumferential surface of a main body further comprises:
providing a feeder, the feeder receiving the polymer resin;
rotating the main body; and
making the feeder face the circumferential surface of the main body, such that the polymer resin is uniformly distributed on the circumferential surface of the main body.
